(19) United States
(12) Patent Application Publication
(10) Pub. No.: US 2016/0178158 A1
(43) Pub. Date: Jun. 23, 2016

(54) LAMP WITH DIFFUSIVE ENCLOSURE

(71) Applicant: Cree, Inc., Durham, NC (US)

(72) Inventor: David James Power, Morrisville, NC (US)

(21) Appl. No.: 14/573,064

(22) Filed: Dec. 17, 2014

(51) Int. Cl. F21V 3/04; B29D 11/00; B29C 45/14; F21K 99/00

(52) U.S. Cl. CPC F21V 3/049; F21K 9/135; B29D 11/0074; B29C 45/14008; F21Y 2101/02

(57) ABSTRACT

An optically transmissive enclosure for a lamp comprises a molded plastic first layer and a light diffusive second layer bonded to the molded plastic first layer over an exit surface of the enclosure comprising a light diffusive in-mold film. The lamp includes a base and a light source operable to emit light when energized through an electrical path from the base. The first layer is substantially clear. A method for making the enclosure is provided.

### BACKGROUND

Lamps, bulbs, light fixtures or the like (hereinafter “lamp”) may be used for general illumination purposes. A typical lamp comprises a light source located in an optically transmissive enclosure. The light source may comprise an incandescent filament, CFL, fluorescent tube, light emitting diode (LED) or the like. The optically transmissive enclosure may be connected to a base for coupling the lamp to a source of power. The base may comprise a threaded base such as an Edison screw, a bayonet cap, pins or other electrical connector that may be removably connected to a socket. In other embodiments the lamp may comprise a fixture that is hard wired to a source of power.

LED lighting systems are becoming more prevalent as replacements for legacy lighting systems. LED systems are an example of solid state lighting (SSL) and have advantages over traditional lighting solutions such as incandescent and fluorescent lighting because they use less energy, are more durable, operate longer, can be combined in multi-color arrays that can be controlled to deliver different color light, and generally contain no lead or mercury. A LED lamp may be made with a form factor that allows it to replace a standard incandescent bulb, or any of various types of fluorescent lamps. LED lamps often include some type of optically transmissive enclosure to allow for localized mixing of colors, collimate light, or provide a particular light pattern that also serves as the enclosure for the electronics and/or the light source.

The optically transmissive enclosure may, in some embodiments, be clear and in other embodiments may have light diffusive properties to diffuse the light exiting the enclosure. The light diffusive properties may be formed by a coating applied to the previously made enclosure. In some embodiments the light diffusive property is formed by using the light diffusive properties of the enclosure material. For example, the enclosure may be made of polycarbonate or other similar material that that has diffusive or light scattering properties.

### SUMMARY OF THE INVENTION

In some embodiments a lamp comprises a base and a light source operable to emit light when energized through an electrical path from the base. An optically transmissive enclosure comprising an exit surface for the light. The enclosure comprises a molded plastic first layer and a light diffusive second layer bonded to the molded plastic first over the exit surface. The light diffusive second layer of the enclosure comprises a light diffusive in-mold film.

The optically transmissive enclosure may be omnidirectional. The optically transmissive enclosure may comprise a reflective surface. The base may comprise an Edison base. The light source may comprise at least one LED. Substantially the entire enclosure may comprise the exit surface. The enclosure may be made of at least one of polycarbonate and acrylic. The light source may comprise one of an incandescent filament, halogen tube, CFL, and fluorescent tube. The second layer may be on an inside surface of the first layer. The second layer may be up to approximately 0.5 mm thick. The second layer may be approximately 0.1 mm thick. The first layer may be approximately 1-1.2 mm thick. The first layer may be clear.

In some embodiments a method of making an optically transmissive enclosure for a lamp comprises providing a mold cavity; inserting a light diffusive film in the mold cavity; injecting a second material into the mold such that the film bonds to the second material to create a molded plastic first layer and a light diffusive second layer bonded to the molded plastic first layer.

The second material may comprise one of polycarbonate and acrylic. The second material may be clear. The mold cavity may have the form factor of an optically transmissive enclosure for a lamp. The diffusive film second layer may be approximately 0.5-0.2 mm thick. The second layer may be approximately 0.1 mm thick. The molded plastic first layer may be approximately 1-1.2 mm thick.

In some embodiments, an optically transmissive enclosure for a lamp comprises a molded plastic first layer defining a light exit surface. A light diffusive second layer is bonded to the molded plastic first layer over the exit surface comprising a light diffusive in-mold film.

### BRIEF DESCRIPTION OF THE DRAWINGS

FIG. 1 is a plan view of an embodiment of the lamp of the invention.

FIG. 2 is a section view of the lamp of FIG. 1.

FIG. 3 is a section view of an alternative embodiment of the lamp of the invention.

FIG. 4 is a broken away plan view of another embodiment of a lamp illustrating an alternative light source.

FIG. 5 is a broken away plan view of another embodiment of a lamp illustrating another alternative light source.

FIG. 6 is a broken away plan view of an alternative embodiment of the lamp of the invention.

FIG. 7 is a broken away plan view of an alternative embodiment of the lamp of the invention.

FIG. 8 is a broken away side view showing another alternate embodiment of the lamp of the invention.

FIG. 9 is a section view of an embodiment of an enclosure of the invention.

FIGS. 10-13 are schematic views illustrating an embodiment of a method of manufacturing the lamp of the invention.

### DETAILED DESCRIPTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element such as a layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” or “top” or “bottom” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

Unless otherwise expressly stated, comparative, quantitative terms such as “less” and “greater”, are intended to encompass the concept of equality. As an example, “less” can mean not only “less” in the strictest mathematical sense, but also, “less than or equal to.”

The terms “LED” and “LED device” as used herein may refer to any solid-state light emitter. The terms “solid state light emitter” or “solid state emitter” may include a light emitting diode, laser diode, organic light emitting diode, and/or other semiconductor device which includes one or more semiconductor layers, which may include silicon, silicon carbide, gallium nitride and/or other semiconductor materials, a substrate which may include sapphire, silicon, silicon carbide and/or other microelectronic substrates, and one or more contact layers which may include metal and/or other conductive materials. A solid-state lighting device produces light (ultraviolet, visible, or infrared) by exciting electrons across the band gap between a conduction band and a valence band of a semiconductor active (light-emitting) layer, with the electron transition generating light at a wavelength that depends on the band gap. Thus, the color (wavelength) of the light emitted by a solid-state emitter depends on the materials of the active layers thereof. In various embodiments, solid-state light emitters may have peak wavelengths in the visible range and/or be used in combination with lumiphoric materials having peak wavelengths in the visible range. Multiple solid state light emitters and/or multiple lumiphoric materials (i.e., in combination with at least one solid state light emitter) may be used in a single device, such as to produce light perceived as white or near white in character. In certain embodiments, the aggregated output of multiple solid-state light emitters and/or lumiphoric materials may generate warm white light output having a color temperature range of from about 2200K to about 6000K.

Solid state light emitters may be used individually or in combination with one or more lumiphoric materials (e.g., phosphors, scintillators, lumiphoric inks) and/or optical elements to generate light at a peak wavelength, or of at least one desired perceived color (including combinations of colors that may be perceived as white). Inclusion of lumiphoric (also called ‘luminescent’) materials in lighting devices as described herein may be accomplished by direct coating on solid state light emitter, adding such materials to encapsulants, adding such materials to lenses, by embedding or dispersing such materials within lumiphor support elements, and/or coating such materials on lumiphor support elements. Other materials, such as light scattering elements (e.g., particles) and/or index matching materials, may be associated with a lumiphor, a lumiphor binding medium, or a lumiphor support element that may be spatially segregated from a solid state emitter.

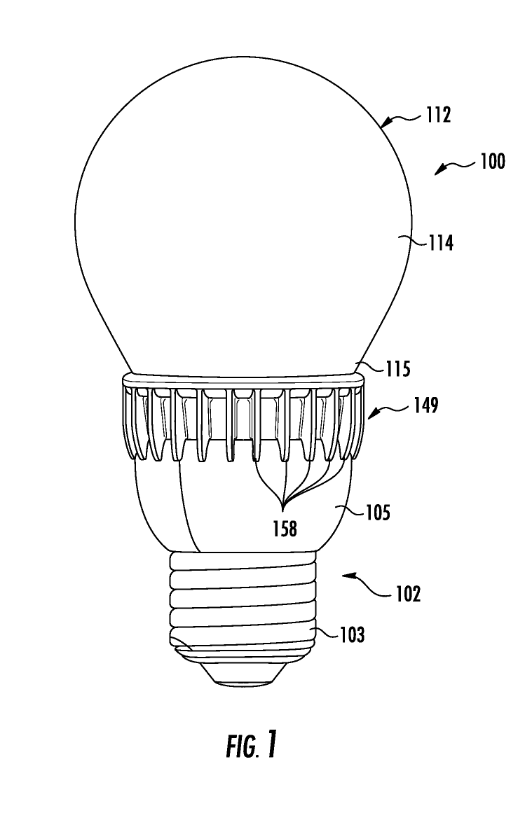

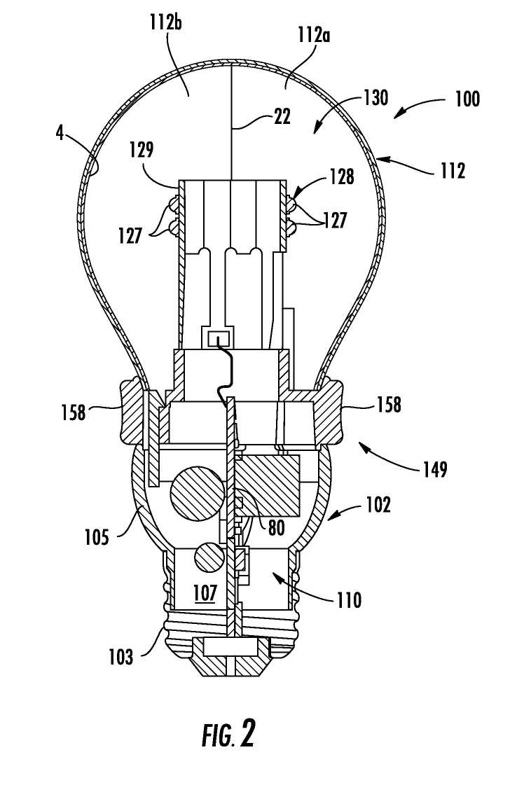

FIGS. 1 and 2 show an embodiment of a LED lamp 100, according to some embodiments of the present invention, embodied in a form factor of a traditional incandescent bulb. In an omnidirectional lamp such as lamp 100 the light is emitted in a wide omnidirectional pattern. In one embodiment, the optically transmissive enclosure 112 and base 102 are dimensioned to be a replacement for an ANSI standard A series bulb such that the dimensions of the lamp 100 fall within the ANSI standards for an A series bulb. In one embodiment, the lamp 100 is configured to be a replacement for an ANSI standard A19 bulb such that the dimensions of the lamp 100 fall within the ANSI standards for an A19 bulb. The dimensions may be different for other ANSI standards including, but not limited to, A21 and A23 standards. In the lamp 100, light is emitted from the lamp in an omnidirectional pattern and in one embodiment the lamp may comply with “ENERGY STAR® Program Requirements for Integral LED Lamps”.

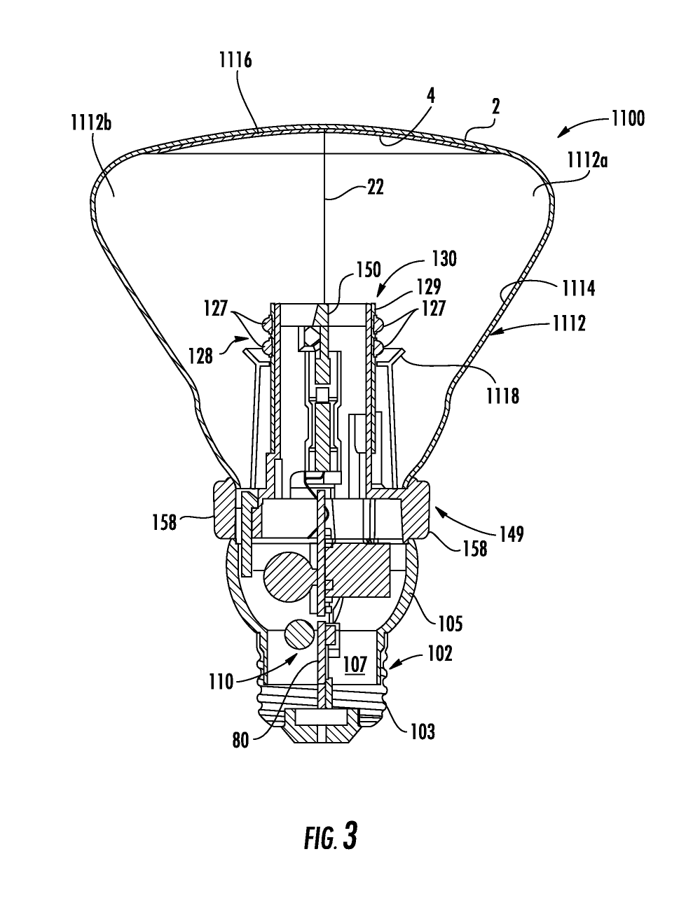

In other embodiments the lamp 1100 may be dimensioned to be a replacement for a standard PAR incandescent bulb, such as a PAR-38 bulb, or a BR-style lamp, as shown in FIG. 3. In some embodiments, the optically transmissive enclosure 112 and base 102 are dimensioned such that the dimensions of the lamp 1100 fall within the ANSI standards for a PAR or BR series bulb. Standard BR type bulbs are reflector bulbs where an internal reflective surface of the enclosure reflects light such that the light beam is emitted in a directional pattern; however, the beam angle is not tightly controlled and may be up to about 90-100 degrees or other fairly wide angles. Standard PAR bulbs are reflector bulbs that reflect light in a direction where the reflective surface is a parabola and the beam angle is tightly controlled. PAR lamps may direct the light in a pattern having a tightly controlled beam angle such as, but not limited to, 10°, 25° and 40°.

The lamp of the invention may be embodied in different forms including standard and non-standard form factors. In other embodiments, the lamp can have any shape, including standard and non-standard shapes. In some embodiments, the lamp may be equivalent to standard watt incandescent light bulbs such as, but not limited to, 40 Watt, 60 Watt, 100 Watt or other wattages. In other embodiments of the lamp, a directional lamp 1100 may be provided as shown in FIG. 3. Enclosure 1112 may comprise an interior surface that defines reflector 1114 that reflects light in a desired pattern. The reflector 1114 may be a parabolic reflector such as found in a PAR style bulb for reflecting the light in a relatively tight pattern or the reflector 1114 may have other shapes such as conical or faceted for reflecting the light in a wider pattern such as may be found in a BR style bulb. The reflector 1114 may be formed as part of the enclosure 1112 or it may be formed as a separate component positioned inside of the enclosure. The reflector 1114 may be formed on the inside of the plastic enclosure 1112 and may be for example made of a reflective aluminum layer. A separate reflector 1118 may be located inside of the enclosure 1112. In a reflector lamp such as a PAR or BR style lamp the interior reflectors reflects at least a portion of the light emitted by the LEDs 127 in the desired pattern out of exit surface 1116. The LEDs 127 may direct some light directly out of the exit surface 1116 of the lamp. Light that is not emitted directly out of the exit surface may be reflected by the reflectors 1114, 1118 toward the exit surface 1116 such that the light is projected from the lamp 100 in a desired directional beam. Numerous configurations of both standard and nonstandard lamps may be provided.

Referring to FIGS. 1-3 a lamp base, such as the Edison base 102, functions as the electrical connector to connect the lamp 100 to an electrical socket or other power source. Depending on the embodiment, other base configurations such as a bayonet cap, pins or other electrical connector are possible to make the electrical connection such as other standard bases or non-standard bases. The base 102 comprises an electrically conductive Edison screw 103 for connecting to an Edison socket and may comprise a housing 105 connected to the Edison screw 103. The Edison screw 103 may be connected to the housing 105 by adhesive, mechanical connector, welding, separate fasteners or the like. The housing 105 may be made of an electrically insulating material such as plastic. In some embodiments the housing 105 may comprise a thermally conductive material where heat may be dissipated from the lamp in part using the housing 105

The housing 105 and the Edison screw 103 define an internal cavity 107 for receiving the electronics 110 of the lamp including the power supply and/or drivers or a portion of the electronics for the lamp. The lamp electronics 110 are electrically coupled to the Edison screw 103 such that the electrical connection may be made from the Edison screw 103 to the lamp electronics 110. The lamp electronics may be mounted on a printed circuit board 80 which includes the power supply, including large capacitor and EMI components that are across the input AC line along with the driver circuitry as described herein. The base may be potted to protect and isolate the lamp electronics 110.

In some embodiments, a driver and/or power supply 110 are included in the base 102 as shown. Base 102 may include the power supply or driver and form all or a portion of the electrical path between the mains and the LEDs 127. The base 102 may also include only part of the power supply circuitry while some smaller components reside with the LED assembly 130. In one example embodiment, the inductors and capacitor that form part of the EMI filter are in the Edison base. Suitable power supplies and drivers are described in U.S. patent application Ser. No. 13/462,388 filed on May 2, 2012 and titled “Driver Circuits for Dimmable Solid State Lighting Apparatus” which is incorporated herein by reference in its entirety; U.S. patent application Ser. No. 12/775,842 filed on May 7, 2010 and titled “AC Driven Solid State Lighting Apparatus with LED String Including Switched Segments” which is incorporated herein by reference in its entirety; U.S. patent application Ser. No. 13/192,755 filed Jul. 28, 2011 titled “Solid State Lighting Apparatus and Methods of Using Integrated Driver Circuitry” which is incorporated herein by reference in its entirety; U.S. patent application Ser. No. 13/339,974 filed Dec. 29, 2011 titled “Solid-State Lighting Apparatus and Methods Using Parallel-Connected Segment Bypass Circuits” which is incorporated herein by reference in its entirety; U.S. patent application Ser. No. 13/235,103 filed Sep. 16, 2011 titled “Solid-State Lighting Apparatus and Methods Using Energy Storage” which is incorporated herein by reference in its entirety; U.S. patent application Ser. No. 13/360,145 filed Jan. 27, 2012 titled “Solid State Lighting Apparatus and Methods of Forming” which is incorporated herein by reference in its entirety; U.S. patent application Ser. No. 13/338,095 filed Dec. 27, 2011 titled “Solid-State Lighting Apparatus Including an Energy Storage Module for Applying Power to a Light Source Element During Low Power Intervals and Methods of Operating the Same” which is incorporated herein by reference in its entirety; U.S. patent application Ser. No. 13/338,076 filed Dec. 27, 2011 titled “Solid-State Lighting Apparatus Including Current Diversion Controlled by Lighting Device Bias States and Current Limiting Using a Passive Electrical Component” which is incorporated herein by reference in its entirety; and U.S. patent application Ser. No. 13/405,891 filed Feb. 27, 2012 titled “Solid-State Lighting Apparatus and Methods Using Energy Storage” which is incorporated herein by reference in its entirety.

The AC to DC conversion may be provided by a boost topology to minimize losses and therefore maximize conversion efficiency. The boost supply is connected to high voltage LEDs operating at greater than 200V. Examples of boost topologies are described in U.S. patent application Ser. No. 13/462,388, entitled “Driver Circuits for Dimmable Solid State Lighting Apparatus”, filed on May 2, 2012 which is incorporated by reference herein in its entirety; and U.S. patent application Ser. No. 13/662,618, entitled “Driving Circuits for Solid-State Lighting Apparatus with High Voltage LED Components and Related Methods”, filed on Oct. 29, 2012 which is incorporated by reference herein in its entirety. Other embodiments are possible using different driver configurations or a boost supply at lower voltages.

The term “electrical path” can be used to refer to the entire electrical path to the light source. For an LED lamp the electrical path may include an intervening power supply disposed between the electrical connection that would otherwise provide power directly to the LEDs and the LED array, or it may be used to refer to the connection between the mains and all the electronics in the lamp, including the power supply. The term may also be used to refer to the connection between the power supply and the LEDs. Electrical conductors run between the light source and the lamp base 102 to carry both sides of the supply to provide critical current to the light source.

The LED assembly 130 may be implemented using a printed circuit board (“PCB”) or other similar component which may be referred to as an LED board 129 and a plurality of LEDs 127. In some embodiments, the LED boards 129 may comprise a PCB, such as FR4 board, a metal core printed circuit board (MCPCB), or other similar structure. The LED boards 129 may comprise a thermally conductive material supported on a dielectric material or other electrically insulating material or materials. The thermally conductive area may be formed as part of the electrical path connecting the LEDs 127 to the electronics 110 in the base 102. The LEDs 127 may be thermally coupled to a heat sink 149 having fins 158 or other thermal dissipating structure to dissipate heat from the lamp to the ambient environment.

The lamp 100 may comprise a plurality of LEDs 127. Multiple LEDs 127 can be used together, forming an LED array 128. The LEDs 127 can be mounted on or fixed within the lamp in various ways. The LEDs 127 in the LED array 128 include LEDs which may comprise an LED die or a plurality of LED dies disposed in an encapsulant such as silicone, and LEDs which may be encapsulated with a phosphor to provide local wavelength conversion. A wide variety of LEDs and combinations of LEDs may be used in the LED assembly 130 as described herein. The LEDs 127 of the LED array 128 are operable to emit light when energized through the electrical path. The LED board 129 may comprise a series of anodes and cathodes arranged in pairs for connection to the LEDs 127. An LED 127 containing at least one LED or LED package is secured to each anode and cathode pair where the LED spans the anode and cathode. The LEDs may be attached to the LED board by soldering. While specific embodiments of LEDs are described herein, a greater or fewer number of anode/cathode pairs and LEDs may be used and the specific placement of the LEDs on LED boards 129 may vary from that shown.

LEDs 127 used with embodiments of the invention can include light emitting diode chips that emit hues of light that, when mixed, are perceived in combination as white light. Phosphors can be used as described to add yet other colors of light by wavelength conversion. For example, blue or violet LEDs can be used in the LED assembly of the lamp and the appropriate phosphor can be in any of the ways mentioned above. LED devices can be used with phosphorized coatings packaged locally with the LEDs or with a phosphor coating the LED die as previously described. For example, blue-shifted yellow (BSY) LED devices, which typically include a local phosphor, can be used with a red phosphor on or in the optically transmissive enclosure or inner envelope to create substantially white light, or combined with red emitting LED devices in the array to create substantially white light.

A lighting system using the combination of BSY and red LED devices referred to above to make substantially white light can be referred to as a BSY plus red or “BSY+R” system. In such a system, the LED devices used include LEDs operable to emit light of two different colors. In one example embodiment, the LED devices include a group of LEDs, wherein each LED, if and when illuminated, emits light having dominant wavelength from 440 to 480 nm. The LED devices include another group of LEDs, wherein each LED, if and when illuminated, emits light having a dominant wavelength from 605 to 630 nm. A phosphor can be used that, when excited, emits light having a dominant wavelength from 560 to 580 nm, so as to form a blue-shifted-yellow light with light from the former LED devices. In another example embodiment, one group of LEDs emits light having a dominant wavelength of from 435 to 490 nm and the other group emits light having a dominant wavelength of from 600 to 640 nm. The phosphor, when excited, emits light having a dominant wavelength of from 540 to 585 nm. A further detailed example of using groups of LEDs emitting light of different wavelengths to produce substantially while light can be found in issued U.S. Pat. No. 7,213,940, which is incorporated herein by reference.

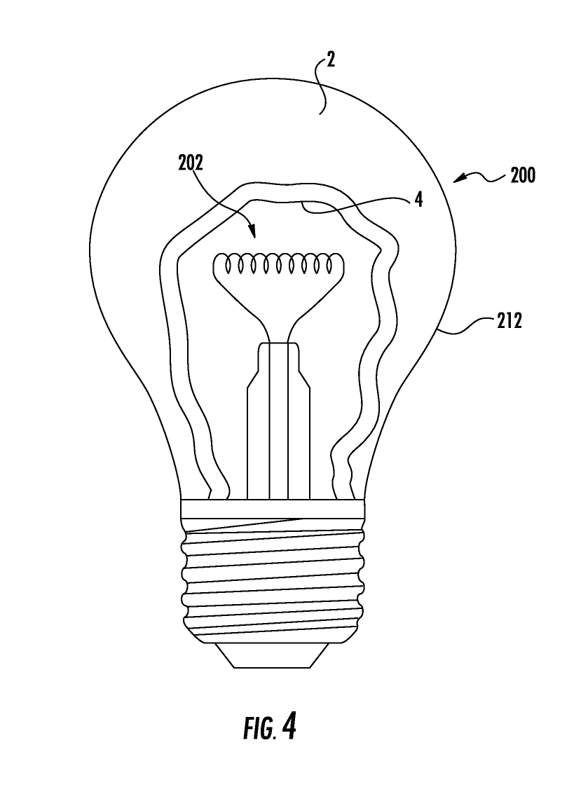

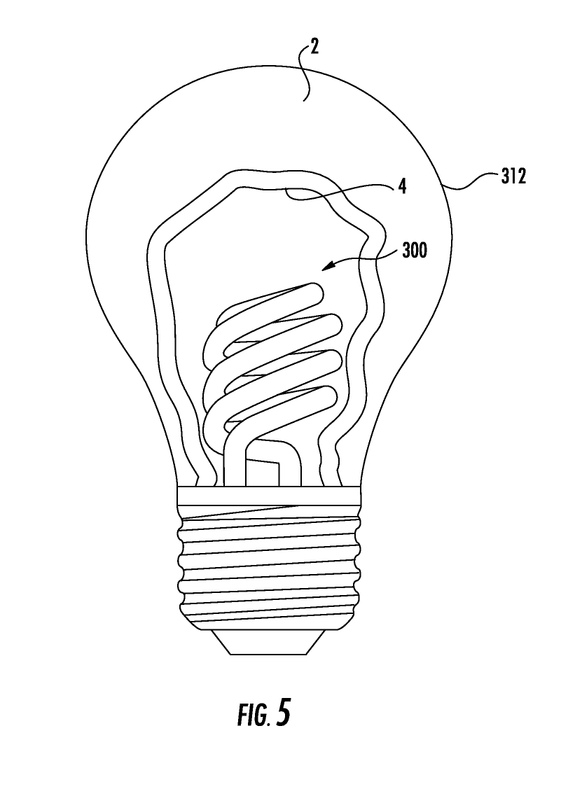

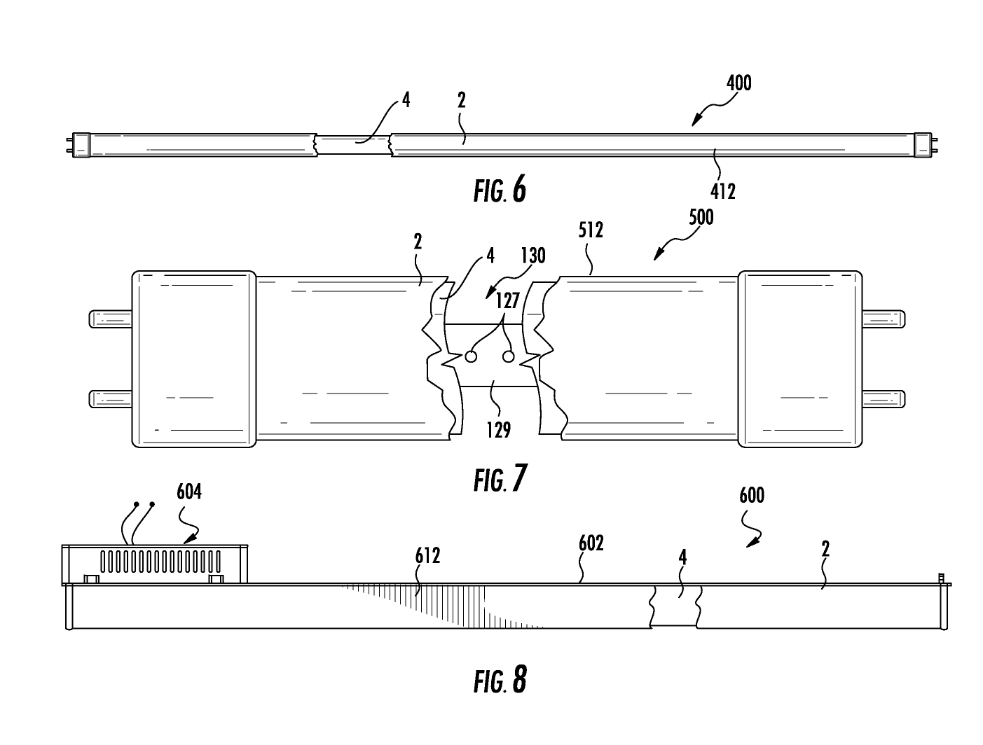

While the specific embodiments of the invention as described disclose an LED light source the light source may comprise any suitable light generating technology including but not limited to a standard incandescent bulb or halogen lamp 200 comprising an incandescent filament 202 (FIG. 4) in an optically transparent enclosure 212, a CFL 300 (FIG. 5) in an optically transmissive enclosure 312, a fluorescent bulb 400 (FIG. 6) in an optically transmissive enclosure 412, LED lamps 500 that may be used as replacements for fluorescent bulbs (FIG. 7) where an LED assembly 130 is contained in an optically transmissive tube 512, or entire light fixtures 600 that may comprise an optically transmissive enclosure 612 mounted on a base 602 and having a power supply 604 that may be hard wired to a source of power (FIG. 8). In the illustrated lamps the optically transmissive enclosures are shown broken-away to show the molded plastic first layer 2 and the diffusive second layer 4 that comprise the optically transmissive enclosure. A wide variety of lamps may use the optically transmissive enclosure as described herein and the form factor of the enclosure may comprise a wide variety of shapes and sizes including traditional shapes and sizes and non-traditional shapes and sizes other than those specifically described and shown herein.

The light source may be contained in an optically transmissive enclosure 112, 1112 through which light emitted by the LEDs 127 is transmitted to the exterior of the lamp. In the embodiments of FIGS. 1 and 2, for example, the enclosure 112 may be entirely optically transmissive where the entire enclosure 112 defines the exit surface through which light is emitted from the lamp. In the embodiment of FIG. 3 the enclosure 1112 of directional lamp 1100 may be partially optically transmissive where the enclosure comprises an optically transmissive exit surface 1116 and a reflector 1114 for reflecting light to the exit surface. The enclosure 112, 1112 may be made of polycarbonate, acrylic, other plastic material or other suitable material that may be molded as described herein. The enclosure may be of similar shape to that commonly used in standard BR and/or PAR incandescent bulbs (for example FIG. 3) or to A series bulbs (for example FIGS. 2 and 3). The exit surface of the enclosure 112, 1112 may be provided with a diffusive or light scattering layer that produces a more uniform far field pattern as described herein.

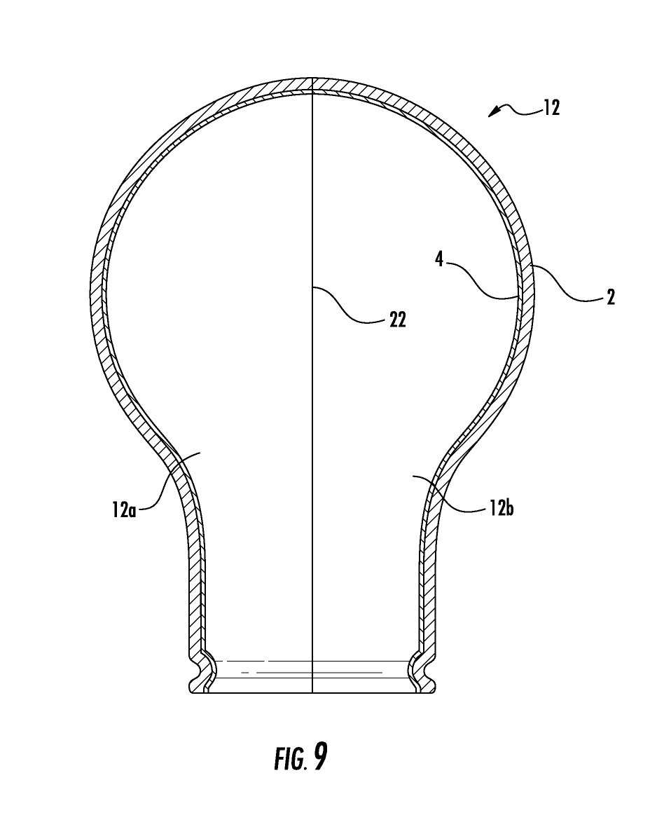

One embodiment of an optically transmissive enclosure 12 for a lamp is shown in FIG. 9 in cross section. The enclosure 12 comprises an outer molded plastic first layer 2 formed of molded plastic. The enclosure may be polycarbonate, acrylic, Acrylonitrile butadiene styrene (ABS) or the like. In one embodiment the first layer 2 is clear or substantially clear such that the lumen loss from light passing through the first layer 2 is minimal. While the first layer 2 is described as clear or substantially clear it is to be understood that the layer 2 may have some diffusive properties and that some losses may occur from transmission through the outer layer. However, the material of the first layer 2 is selected to minimize light loss and to be substantially clear. The first layer 2 is formed of a molded plastic and is rigid to define the form factor of the enclosure 12. The enclosure 12 may assume any form factor including form factors other than as specifically shown and described herein. The enclosure 12 comprises a light diffusive second layer 4 formed of a thin film of light diffusive material. The light diffusive second layer 4 is bonded directly to the first layer 2 using an in-mold decoration process such that the light diffusive second layer 4 and rigid first layer 2 are formed in a single process and make a one-piece enclosure where the two layers are bonded directly to one another. While the light diffusive second layer 4 is shown inside of the rigid first layer 2, the light diffusive second layer 4 may be formed on the outside of the first layer 2.

To create the enclosure 12 an in-mold decoration technique is used. One wall of the mold cavity is lined with a diffusive film. The plastic material that forms the rigid first layer 2 is injected into the mold such that the diffusive film is bonded to the first layer and forms part of the enclosure 12. When the enclosure 12 is removed from the mold the diffusive film forms a diffusive layer 4 over the exit surface of the enclosure that diffuses and scatters light emitted from the lamp. The use of the diffusive layer 4 formed using the IMD process creates a thin diffusive layer over the enclosure without additional manufacturing steps. In one existing enclosure the diffusive layer is added to the enclosure after formation of the enclosure in a separate processing step. The diffusive layer may be added as a paint, coating or the like that requires additional processing steps and time. In other existing enclosures the rigid enclosure is made of a material where the material of the enclosure itself has light diffusive properties. Where the diffusive layer is formed by the material of the enclosure such as by the formulation of the resin used in the molding the enclosure, the diffusive layer is formed over the entire thickness of the enclosure. In a typical lamp the enclosure may be 1-1.2 mm thick. A diffusive layer of such a thickness causes losses in the emitted light that adversely affect the efficiency of the lamp. Using the IMD process described herein the diffusive film layer may be up to approximately 0.5 mm thick and in one embodiment is approximately 0.1 mm thick. The diffusive layer may be bonded to a clear rigid first layer that may be approximately 1-1.2 mm thick. As a result, the losses from the diffusive layer 4 in the lamp of the invention is significantly less than the losses in molded enclosure that relies on the material of the enclosure to form the diffusive layer. It is to be understood that the relative dimensions of the first and second layers are exaggerated in the figures in order to better illustrate the invention.

Referring more particularly to FIGS. 10-13 an embodiment of a process for forming the diffusive layer as part of a lamp enclosure is described. The mold 20 as described herein is a two-piece mold where the two pieces 20a and 20b form a mold cavity 28 that defines one-half of the enclosure 12. Two enclosure halves 12a and 12b are secured together at a seam 22 (see FIG. 9) to form the complete enclosure. The halves may be joined mechanically, using adhesive, by a welding operation or by other mechanisms or combinations of mechanisms. While a two-piece mold is described herein the mold may comprise more than two mold pieces.

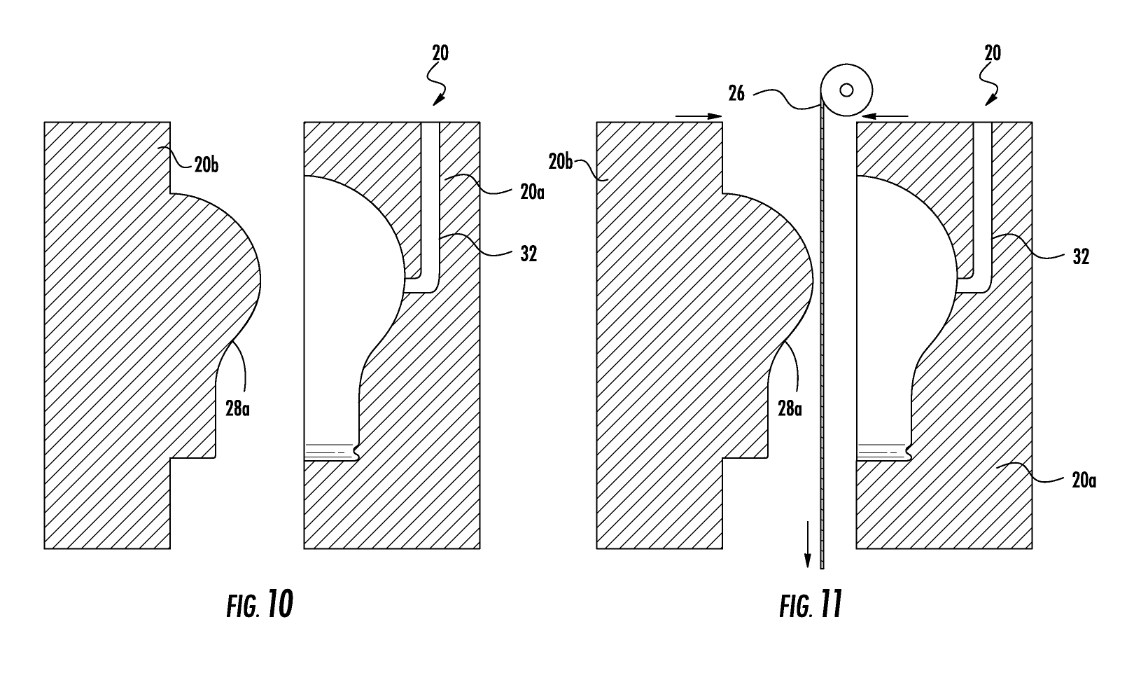

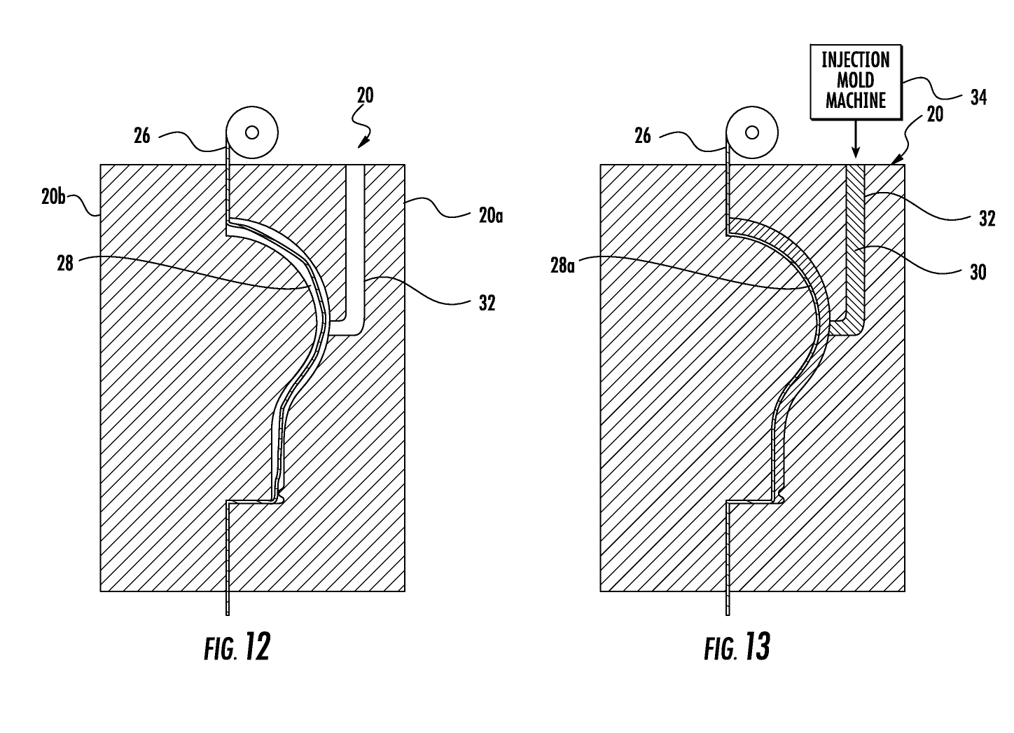

A film layer of a light diffusive material 26 is inserted into the mold (FIG. 11). The light diffusive layer may comprise polycarbonate, PET (Polyethylene terephthalate) or other suitable materials. In one embodiment the film material is supported on rollers and is arranged to span the mold cavity 28. The mold parts 20a, 20b are closed to trap the film layer in the mold cavity 28 (FIG. 12). In one embodiment the diffusive layer 4 is located in the mold such that it is on the inside of the enclosure in the completed enclosure. Molten plastic 30 such as polycarbonate is introduced into the mold cavity 28 from an injection molding machine 34 via an inlet port 32 to one side of the film layer 26. In one embodiment the plastic 30 is disposed on the outside of the enclosure part. The pressure of the molten plastic 30 forces the film layer 26 against the wall 28a of mold cavity 28. The heat of the molding process bonds the film layer 26 to the inside surface of the molded plastic layer. The mold 20 may be opened and the film layer 26 may be trimmed to fit the molded first layer 2.

In some embodiments the film layer may be preformed to the shape of the mold cavity before the film is located in the mold. In other embodiments the film may be shaped in the mold prior to the injection of the plastic. For example, a vacuum may be used to pull the film layer against the wall 28a of mold cavity 28 or high pressure gas may introduced into the mold cavity 28 to press the film layer against the wall 28a of the mold cavity. The use of a preformed film layer or of a negative or positive pressure molding step may be advantageously used where the aspect ratio of the molded part is high or where the part has complex curves. The introduction of the molten plastic 30 into the mold cavity 28 presses the film layer 26 between the wall 28a of the mold cavity 28 and the molten plastic 30. The pressure and heat bond the film layer to the inside surface of the molded plastic enclosure part.

Each molded part described above forms one half 12a, 12b of the enclosure. The enclosure parts 12a, 12b are joined together at a seam 22 by any suitable mechanism such that the enclosure parts form a complete enclosure. The enclosure may be formed to have any suitable size and geometry. While a two part enclosure is described, the enclosure may be made of one, or three or more parts that are joined together to create the complete enclosure.

As previously explained the film layer 4 is disposed over the inside surface of the enclosure. The film layer 4 is selected to provide the desired light diffusive/scattering effect. The thickness of the film layer may be on the order of one-tenth the thickness of the plastic enclosure. The plastic enclosure may be made of a clear or transparent material such that the relatively thick enclosure does not cause significant losses when compared to the same thickness enclosure made of a light diffusive material. The diffusive layer is relatively thin such that the light diffusive properties are provided with minimal losses.

In some embodiments printed information or other visual information, such trademarks, logos, lamp specifications (hereinafter “indicia”) may be printed on the film layer prior to molding of the enclosure. The indicia may be located at the distal end of the bulb in the same position as such information is provided on a traditional bulb. While printed information may be provided on the film that is visible in the finished bulb, the primary purpose of the film layer is to provide a light diffusive or light scattering layer over the exit surface of the enclosure. While the indicia may be provided, the indicia comprises a very small portion of the area of the film layer and the film layer functions primarily as a light transmissive layer that functions to diffuse or scatter the light emitted from the lamp.

Although specific embodiments have been shown and described herein, those of ordinary skill in the art appreciate that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

1. A lamp comprising:
a base;
a light source operable to emit light when energized through an electrical path from the base;
an optically transmissive enclosure, comprising an exit surface for emitting the light, the enclosure comprising a molded plastic first layer and a light diffusive second layer bonded to the molded plastic first layer over the exit surface, the light diffusive second layer comprising a light diffusive in-mold film.

2. The lamp of claim 1 wherein the optically transmissive enclosure is omnidirectional.

3. The lamp of claim 1 wherein the optically transmissive enclosure comprises a reflective surface.

4. The lamp of claim 1 wherein the base comprises an Edison base.

5. The lamp of claim 1 wherein the light source comprises at least one LED.

6. The lamp of claim 1 wherein substantially the entire enclosure comprises the exit surface.

7. The lamp of claim 7 wherein the enclosure is made of at least one of polycarbonate, acrylic, and Acrylonitrile butadiene styrene (ABS).

8. The lamp of claim 1 wherein the light source comprises one of an incandescent filament, halogen tube, CFL, and fluorescent tube.

9. The lamp of claim 1 wherein the second layer is on an inside surface of the first layer.

10. The lamp of claim 1 wherein the diffusive film layer is up to approximately 0.5 mm thick.

11. The lamp of claim 1 wherein the diffusive film layer is approximately 0.1 mm thick.

12. The lamp of claim 1 wherein the molded plastic first layer is approximately 1-1.2 mm thick.

13. The lamp of claim 1 wherein the molded plastic first layer is clear.

14. A method of making an optically transmissive enclosure for a lamp comprising;
providing a mold cavity;
inserting a light diffusive film in the mold cavity;
injecting a second material into the mold such that the film bonds to the second material to create a molded plastic first layer and a light diffusive second layer bonded to the molded plastic first layer.

15. The method of claim 14 wherein the second material comprises one of polycarbonate, acrylic, Acrylonitrile butadiene styrene (ABS).

16. The method of claim 15 wherein the second material is clear.

17. The method of claim 15 wherein the mold cavity has the form factor of an optically transmissive enclosure for a lamp.

18. The method of claim 14 wherein the light diffusive second layer is approximately 0.5-0.2 mm thick.

19. The lamp of claim 14 wherein the light diffusive second layer is approximately 0.1 mm thick.

20. The lamp of claim 14 wherein the molded plastic first layer is approximately 1-1.2 mm thick.

21. An optically transmissive enclosure for a lamp comprising:
a molded plastic first layer defining a light exit surface; and
a light diffusive second layer bonded to the molded plastic first layer over the exit surface comprising a light diffusive in-mold film.

22. The lamp of claim 21 wherein the light diffusive second layer is made of at least one of polycarbonate and PET (Polyethylene terephthalate)
